(19) United States
(12) Patent Application Publication
(10) Pub. No.: US 2010/0060525 A1
(43) Pub. Date: Mar. 11, 2010

(54) MULTI-BAND ANTENNA

(76) Inventors: Wen-Chieh Yang, Tu-Cheng City (TW); Yu-Yuan Wu, Tu-Cheng City (TW); Kai Shih, Tu-Cheng City (TW); Hsin-Tsung Wu, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/204,920

(22) Filed: Sep. 5, 2008

(51) Int. Cl. H01Q 1/38

(52) U.S. Cl. 343/700 MS

(57) ABSTRACT

A multi-band antenna includes a feed-in element having a feed-in point thereon. A first connecting portion extends from one side of the feed-in element. A ground element connects to a side of the first connecting portion and is parallel to the feed-in element. A holding portion perpendicularly extends from a side of the ground element opposite the first connecting portion. A second connecting portion perpendicularly bends and extends from a side of the feed-in element opposite the first connecting portion. A first radiating portion extends from one side of the second connecting portion. A second radiating portion extends from the other side of the second connecting portion opposite the first radiating portion. The first radiating portion and part of the second radiating portion are disposed at one side of the holding portion. The rest part of the second radiating portion is disposed at the other side of the holding portion.

### BACKGROUND OF THE INVENTION

1. Field of the Invention

The present invention relates to an antenna, and particularly to a multi-band antenna operating at various wireless communication bands.

2. The Related Art

A conventional multi-band antenna is shown in FIG. 1. The multi-band antenna has an antenna body 100. The antenna body 100 is of a metal sheet. An L-shaped groove 10 is formed in the antenna body 100. The groove 10 includes a first groove 12 and a second groove 14. The first groove 12. straightly extends downwardly from a top side of the antenna body 100. The second groove 14 horizontally extends rightward from a bottom of the first groove 12. The first groove 12 is perpendicular to the second groove 14. A first radiating portion 20 operating at a lower frequency band is formed in the left of the first groove 12. A second radiating portion 30 operating at a higher frequency band is formed between the right of the first groove 12 and the top of the second groove 14. The first radiating portion 20 obtains a first frequency band GSM 900. The second radiating portion 30 obtains a second frequency band DCS1800 and PCS1900.

However, because the first radiating portion 20 and the second radiating portion 30 of the antenna body 100 are disposed in a common plane, the occupancy space of the antenna body 100 is relative large. If the occupancy space is reduced, the characteristic and the function of transmitting and receiving electromagnetic signals of the multi-band antenna would drop.

### SUMMARY OF THE INVENTION

Accordingly, an object of the present invention is to provide a multi-band antenna with improved structure to reduce the occupancy space without weakening the characteristic of transmitting and receiving electromagnetic signals. The multi-band antenna includes a feed-in element having a feed-in point thereon. A first connecting portion extends from one side of the feed-in element. A ground element connected to one side of the first connecting portion has a ground point thereon. The ground element is parallel to the feed-in element. A holding portion substantially perpendicularly extends from a side of the ground element opposite the first connecting portion. A second connecting portion substantially perpendicularly bends and extends from a side of the feed-in element opposite the first connecting portion. A first radiating portion extends from one side of the second connecting portion. A second radiating portion extends from the other side of the second connecting portion opposite the first radiating portion. The first radiating portion and part of the second radiating portion are disposed at one side of the holding portion. The rest part of the second radiating portion is disposed at the other side of the holding portion.

When the multi-band antenna is configured to a printed circuit board, the first radiating portion and part of the second radiating portion are disposed at one side of the printed circuit board and the rest part of the second radiating portion is disposed at the other side of the printed circuit board, and therefore, the occupancy space of the multi-band antenna is reduced without the characteristic and the function of transmitting and receiving electromagnetic signals of the multi-band antenna being weakened.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a conventional multi-band antenna;

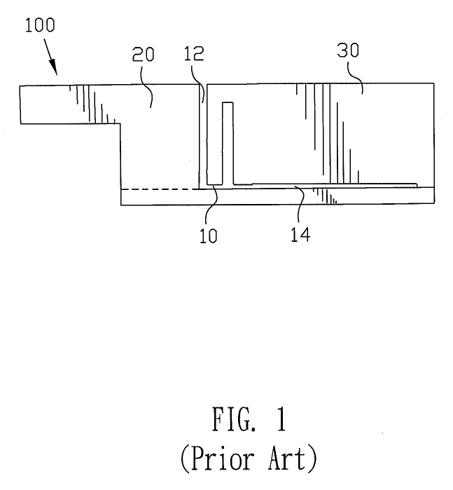

FIG. 2 is a perspective view of a multi-band antenna according to the present invention;

FIG. 3 is a perspective view of the multi-band antenna assembled with a printed circuit board;

FIG. 4 shows the efficiency E against frequency F in MHz when the multi-band antenna operates at GSM900;

FIG. 5 shows the efficiency E against frequency F in MHz when the multi-band antenna operates at DCS and PCS; and

FIG. 6 shows a Voltage Standing Wave Ratio (VSWR) test chart of the multi-band antenna.

### DETAILED DESCRIPTION OF THE PREFERRED EMBODIMENT

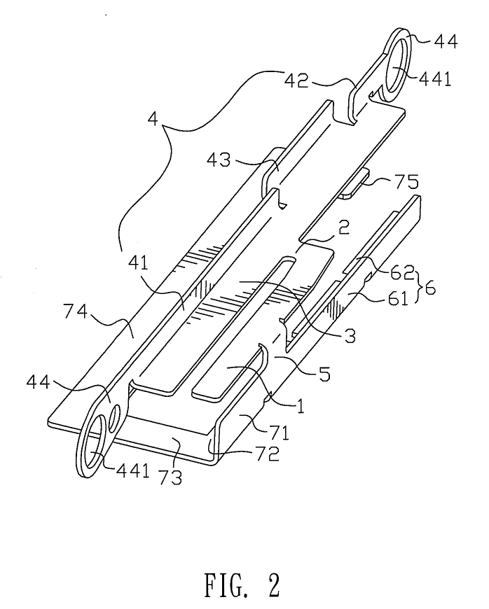

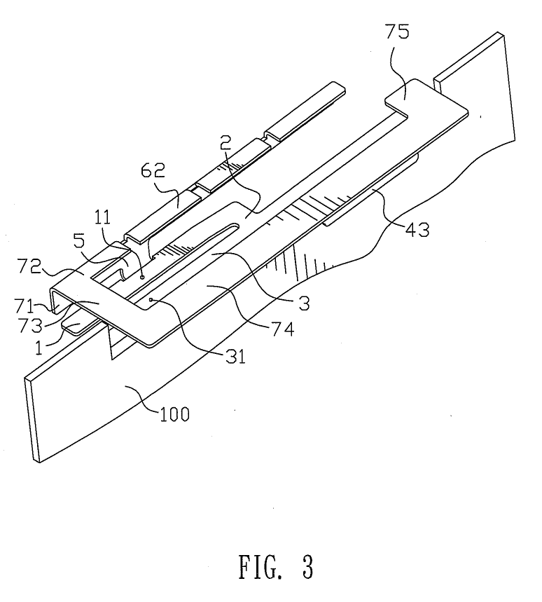

Referring to FIG. 2 and FIG. 3, a preferred embodiment of a multi-band antenna according to the present invention is shown. The multi-band antenna includes an elongated feed-in element 1 with a feed-in point 11 provided thereon. An end of one side of the feed-in element 1 perpendicularly extends to form a first connecting portion 2. A free end of the first connecting portion 2 is connected with an elongated ground element 3. The ground element 3 is parallel to the feed-in element 1. A ground point 31 is defined on the ground element 3. Two ends of one side, which is opposite to the side where the first connecting portion 2 is connected, of the ground element 3 perpendicularly extend upwardly to form a first holding portion 41 and a second holding portion 42 spaced away from the first holding portion 41. The side of the ground element 3 between the first holding portion 41 and the second holding portion 42 horizontally extends outwardly and perpendicularly bends upwardly to form a third holding portion 43 of a substantial L shape. The first holding portion 41, the second holding portion 42 and the third holding portion 43 constitute a holding portion 4. Free ends of the first holding portion 41 and the second holding portion 42 opposite the third holding portion 43 respectively extend outwardly to form a holding plate 44. Each holding plate 44 defines a mounting hole 441 therein.

A middle portion of the side of the feed-in element 1 opposite the first connecting portion 2 perpendicularly bends and extends in a direction away from the holding portion 4 downwardly to form a second connecting portion 5. A right side of the second connecting portion 5 extends rightward to form a first radiating portion 6. The first radiating portion 6 is a high-frequency radiating portion and disposed at one side of the holding portion 4. The first radiating portion 6 includes a first section 61 extending from the right side of the second connecting portion 5 and a second section 62 perpendicularly bending and extending inwardly from a bottom side of the first section 61. The first section 61 is perpendicular to the feed-in element 1 and the second section 62 is parallel to the feed-in element 1.

A left side of the second connecting portion 5 extends leftward to form a second radiating portion 7. The second radiating portion 7 is a lower-frequency radiating portion and includes a first section 71, a second section 72, a third section 73, a fourth section 74 and a fifth section 75, all of which are connected with each other in sequence. The first section 71 extends from the left side of the second connecting portion 5 and is perpendicular to the feed-in element 1. The second section 72 perpendicularly bends and extends inwardly from a bottom side of the first section 71. The second section 72 is parallel to the feed-in element 1 and disposed such that a gap is defined between the two. The third section 73 perpendicularly extends from an end of an inner side of the second section 72 opposite the first section 71. The fourth section 74 perpendicularly extends rightward from an end of an inner side of the third section 73 opposite the second section 72 and is parallel to the feed-in element 1. The fifth section 75 perpendicularly extends from an end of an inner side of the fourth section 74 opposite the third section 73 and is parallel to the third section 73. The first section 71, the second section 72, parts of the third section 73 and the fifth section 75 are disposed at the same side of the holding portion 4 as the first radiating portion 6. The rest parts of the third section 73 and the fifth section 75, the fourth section 74 are disposed at the other side of the holding portion 4 opposite the first radiating portion 6.

As the total electrical length from the feed-in point 11 of the feed-in element 1 to the end of the first radiating portion 6 via the second connecting portion 5 is substantially equal to a quarter of the wavelength corresponding to a frequency 1850 MHz, the first radiating portion 6 resonates at frequency bands DCS1800 and PCS1900.

As the total electrical length from the feed-in point 11 of the feed-in element 1 to the end of the fifth section 75 of the second radiating portion 7 via the second connecting portion 5 is substantially equal to a quarter of the wavelength corresponding to a frequency 920 MHz, the second radiating portion 7 resonates at a frequency band GSM900.

When the multi-band antenna is configured to a printed circuit board 100, the printed circuit board 100 is fixed between the first holding portion 41, the second holding portion 42 and the third holding portion 43. Screws (not shown) engage with the mounting holes 441 of the holding plate 44 to fix the multi-band antenna onto the printed circuit board 100. The first radiating portion 6, the first section 71 and the second section 72 of the second radiating portion 7, parts of the third section 73 and the fifth section 75 of the second radiating portion 7 are disposed at one side of printed circuit board 100. The rest parts of the third section 73 and the fifth section 75, the fourth section 74 of the second radiating portion 7 are disposed at the other side of the printed circuit board 100.

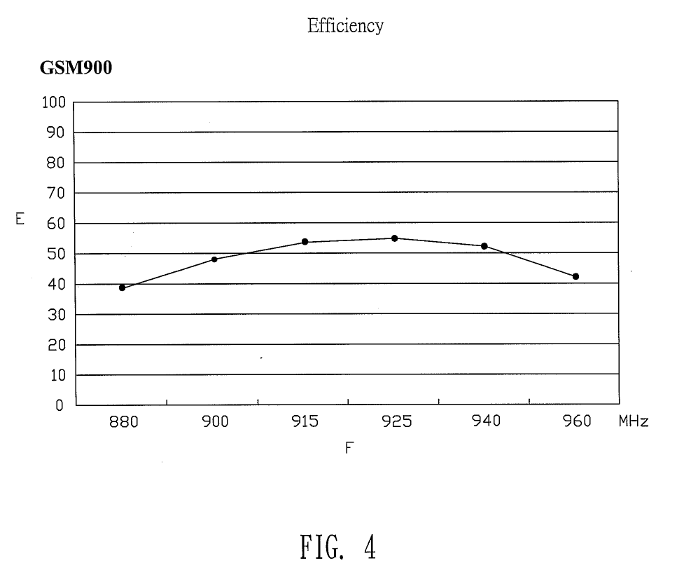

FIG. 4 shows the efficiency E against frequency F in MHz when the multi-band antenna operates at GSM900. When the multi-band antenna operates at a frequency range covering between 900 MHz and 940 MHz, the efficiency is between 47 percentages and 55 percentages.

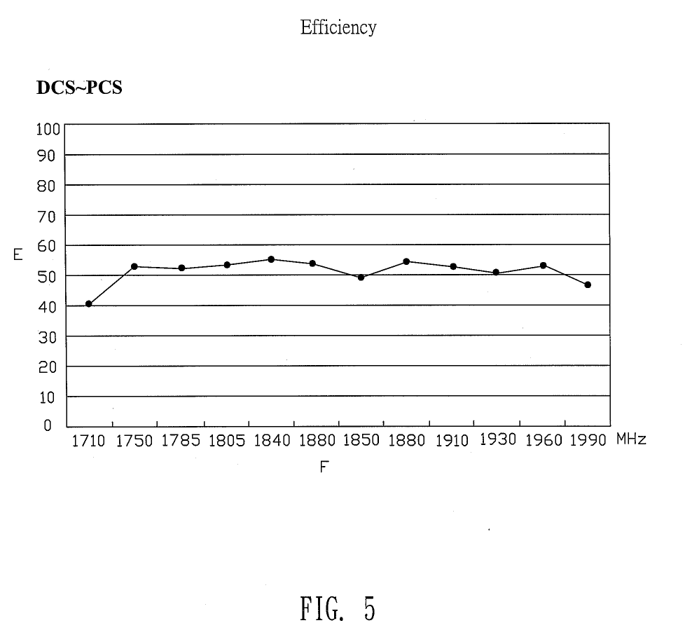

FIG. 5 shows the efficiency E against frequency F in MHz when the multi-band antenna operates at DCS and PCS. When the multi-band antenna operates at the frequency range covering between 1750 MHz and 1880 MHz, the efficiency is between 52 percentages and 56 percentages. When the multi-band antenna operates at the frequency range covering between 1880 MHz and 1960 MHz, the efficiency is between 50 percentages and 55 percentages.

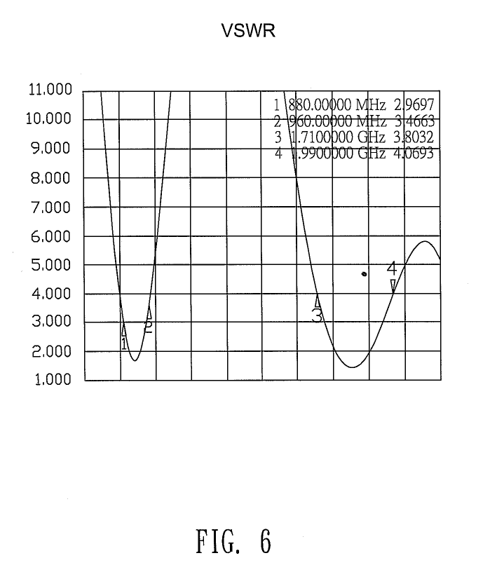

FIG. 6 shows a Voltage Standing Wave Ratio (VSWR) test chart of the multi-band antenna when the multi-band antenna operates at wireless communication. When the multi-band antenna operates at 880 MHz, the VSWR value is 2.9697. When the multi-band antenna operates at 960 MHz, the VSWR value is 3.4663. The VSWR value is 3.8032, when the multi-band antenna operates at 1710 MHz. The VSWR value is 4.0693, when the multi-band antenna operates at 1990 MHz.

As described above, when the multi-band antenna is configured to the printed circuit board 100, the first radiating portion 6, the first section 71 and the second section 72 of the second radiating portion 7 and parts of the third section 73 and the fifth section 75 of the second radiating portion 7 are disposed at one side of printed circuit board 100. The rest parts of the third section 73 and the fifth section 75, the fourth section 74 of the second radiating portion 7 are disposed at the other side of the printed circuit board 100. With this construction, the occupancy space of the multi-band antenna is reduced without the characteristic and the function of transmitting and receiving electromagnetic signals of the multi-band antenna being weakened. Furthermore, the multi-band antenna can reduce the influence between the first radiating portion 6 disposed at one side of the printed circuit board 100 and the second radiating portion 7 disposed at the other side of the printed circuit board 100, and therefore, the characteristic and the function of transmitting and receiving electromagnetic signals are enhanced.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A multi-band antenna, comprising:
a feed-in element having a feed-in point formed thereon;
a ground element substantially located to be parallel with the feed-in element and connected with the feed-in element by a first connecting portion;
a holding portion substantially perpendicularly extending from one side, which is opposite to the other side where the first connecting portion is connected, of the ground element;
a second connecting portion substantially perpendicularly extending opposite the holding portion from one side of the feed-in element opposite the first connecting portion;
a first radiating portion extending from one side of the second connecting portion; and
a second radiating portion extending from the other side of the second connecting portion opposite the first radiating portion;
wherein the first radiating portion and part of the second radiating portion are disposed at one side of the holding portion, while the rest part of the second radiating portion is disposed at the other side of the holding portion opposite the first radiating portion.

2. The multi-band antenna as claimed in claim 1, wherein the first radiating portion is a high-frequency radiating portion.

3. The multi-band antenna as claimed in claim 1, wherein the first radiating portion has a first section connected to the one side of the second connecting portion and a second section bending from one side of the first section, the first section is substantially perpendicular to the feed-in element and the second section is substantially parallel with and opposite the feed-in element.

4. The multi-band antenna as claimed in claim 1, wherein the second radiating portion is a lower-frequency radiating portion.

5. The multi-band antenna as claimed in claim 1, wherein the second radiating portion has a first section connected to the other side of the second connecting portion and substantially perpendicular to the feed-in element, a second section bending and extending from one side of the first section to substantially parallel to the feed-in element and opposite the feed-in element, a third section substantially perpendicularly extending from an end of an inner side of the second section opposite the first section and intersecting with the holding portion, a fourth section substantially perpendicularly extending from an end of the third section opposite the second section to parallel to the feed-in element and disposed at the other side of the holding portion.

6. The multi-band antenna as claimed in claim 5, wherein the second radiating portion further comprises a fifth section substantially perpendicularly extending from an end of an inner side of the fourth section opposite the third section to parallel to the third section and intersecting with the holding portion.

7. The multi-band antenna as claimed in claim 1, wherein the holding portion has a first holding portion, a second holding portion and a third holding portion, the first holding portion and the second holding portion bend in opposition with the second connecting portion from two ends of a side of the ground element opposite the first connecting portion, the third holding portion extends and then bends in opposition with the second connecting portion from the side of the ground element opposite the first connecting portion to show a substantial L shape and is located between the first holding portion and the second holding portion.

8. The multi-band antenna as claimed in claim 7, wherein outer ends of the first holding portion and the second holding portion opposite the third holding portion respectively extend outwardly to form a holding plate, and each holding plate defines a mounting hole therein.
